(19) United States
(12) Patent Application Publication
(10) Pub. No.: US 2011/0066438 A1
(43) Pub. Date: Mar. 17, 2011

(54) CONTEXTUAL VOICEOVER

(75) Inventors: Aram Lindahl, Menlo Park, CA (US); Gints Valdis Klimanis, Sunnyvale, CA (US); Devang Kalidas Naik, San Jose, CA (US)

(73) Assignee: APPLE INC., Cupertino, CA (US)

(21) Appl. No.: 12/560,192

(22) Filed: Sep. 15, 2009

(51) Int. Cl. G10L 13/00; H04M 1/64

(52) U.S. Cl. 704/258; 379/67.1

(57) ABSTRACT

A method for providing voice feedback with playback of media on an electronic device is provided. In one embodiment, the method may include determining one or more characteristics of the media with which the voice feedback is associated. For instance, the media may include a song, and the determined characteristics could include one or more of genre, reverberation, pitch, balance, timbre, tempo, or the like. The method may also include processing the voice feedback to alter characteristics thereof based on the one or more determined characteristics of the associated media. Additional methods, devices, and manufactures are also disclosed.

### BACKGROUND

1. Technological Field

The present disclosure relates generally to providing voice feedback information with playback of media files from a device and, more particularly, to techniques for varying one or more characteristics of such voice feedback output based on the context of an associated media file.

2. Description of the Related Art

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In recent years, the growing popularity of digital media has created a demand for digital media player devices, which may be portable or non-portable. In addition to providing for the playback of digital media, such as music files, some digital media players may also provide for the playback of secondary media items that may be utilized to enhance the overall user experience. For instance, secondary media items may include voice feedback files providing information about a current primary track or other audio file that is being played on a device. As will be appreciated, voice feedback data may be particularly useful where a digital media player has limited or no display capabilities, or if the device is being used by a disabled person (e.g., visually impaired).

The voice feedback may be reproduced concurrently with playback of an associated primary media item, such as a song or an audiobook. During playback of a song, for instance, the volume of the song may be temporarily reduced to allow a listener to more easily hear voice feedback (e.g., a voiceover announcement) identifying the song title, an album title, an artist name, or some other information. Following the voice feedback, the volume of the song may generally return to its previous level. Such a process of temporarily reducing the volume of the primary media item for output of the voice feedback is commonly referred to as “ducking” of the primary media item. It is also noted that the voice feedback may be provided in various manners, such as via natural or synthesized speech.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to processing voice feedback data based on contextual parameters of a primary media item with which it is associated. For instance, in one embodiment, an electronic device may determine one or more parameters of audio data (e.g., music data or speech data) of the primary media item. Such a determination may be accomplished through analysis of the audio data itself, or through analysis of metadata associated with the music data. The determined parameters may relate to one or more of reverberation, genre, timbre, pitch, equalization, tempo, volume, or some other parameter of the audio data.

The voice feedback data may then be processed to vary one or more characteristics of the voice feedback data based on the one or more parameters determined from the audio data. Voice feedback characteristics that may be varied through such processing may include pitch, tempo, reverberation, mono or stereo imaging, timbre, equalization, and volume, among others. Particularly, in some embodiments, the variation of voice feedback characteristics may provide facilitate better integration of the voice feedback with the primary audio data with which it is associated, thereby enhancing the listening experience of a user.

Various refinements of the features noted above may exist in relation to the presently disclosed embodiments. Additional features may also be incorporated in these various embodiments as well. These refinements and additional features may exist individually or in any combination. For instance, various features discussed below in relation to one or more of the illustrated embodiments may be incorporated into any of the above-described embodiments alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a front view of an electronic device in accordance with aspects of the present disclosure;

FIG. 2 is a block diagram depicting components of an electronic device or system, such as that of FIG. 1, in accordance with aspects of the present disclosure;

FIG. 3 is a schematic illustration of a networked system through which digital media may be requested from a digital media content provider in accordance with aspects of the present disclosure;

FIG. 4 is a flowchart depicting a method for creating and associating secondary media files, such as voiceover announcements, with a corresponding primary media file in accordance with aspects of the present disclosure;

FIG. 5 is a graphical depiction of a media file including audio material and metadata in accordance with aspects of the present disclosure;

FIG. 6 is a flowchart depicting a method of processing a voiceover announcement based on a primary media item with which it is associated, in accordance with aspects of the present disclosure;

FIG. 7 is a schematic block diagram depicting the concurrent playback of a primary media file and a secondary media file by an electronic device, such as the electronic device of FIG. 1, in accordance with aspects of the present disclosure;

FIG. 8 is a flowchart depicting a method of modifying a reverberation characteristic of a voiceover announcement based on a reverberation characteristic of the audio material with which the voiceover announcement is associated, in accordance with aspects of the present disclosure;

FIG. 9 is a flowchart depicting a method of modifying a reverberation characteristic of a voiceover announcement based on metadata pertaining to audio material with which the voiceover announcement is associated, in accordance with aspects of the present disclosure; and

FIG. 10 is a flowchart depicting a process of altering a voiceover announcement based on the genre of audio material associated with the voiceover announcement, in accordance with aspects of the present disclosure.

### DETAILED DESCRIPTION OF SPECIFIC EMBODIMENTS

One or more specific embodiments are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

The present application is generally directed to providing audio feedback to a user of an electronic device. Particularly, the present application discloses techniques for providing audio feedback concurrently with playback of media items by an electronic media-playing device, and for processing such audio feedback based on the media items. For example, and as discussed in greater detail below, the audio feedback may include a voiceover announcement to aurally provide various information regarding media playback to a user, such as an indication of a song title, an album title, the artist or performer, a playlist title, and so forth. In one embodiment, characteristics of the voiceover announcement may be altered based on parameters of the associated song (or other media). Such alteration may facilitate better integration of the voiceover announcement with the song or other audio material, thereby enhancing the listening experience of the user.

Before continuing, several terms used within the present disclosure will be first defined in order to facilitate a better understanding of the disclosed subject matter. For instance, as used herein, the term “primary,” as applied to media, shall be understood to refer to a main audio track that a user generally selects for listening, whether it be for entertainment, leisure, educational, or business purposes, to name just a few. By way of example only, a primary media file may include music data (e.g., a song by a recording artist), speech data (e.g., an audiobook or news broadcast), or some other audio material. In some instances, a primary media file may be a primary audio track associated with video data and may be played back concurrently as a user views the video data (e.g., a movie or music video). The primary media file may also include various metadata, such as information pertaining to the audio material. Examples of such metadata may include song title, album title, performer, genre, and recording year, although it will be appreciated that such metadata may also or instead include other items of information.

The term “secondary,” as applied to media, shall be understood to refer to non-primary media files that are typically not directly selected by a user for listening purposes, but may be played back upon detection of a feedback event. Generally, secondary media may be classified as either “voice feedback data” or “system feedback data.” “Voice feedback data” shall be understood to mean audio data representing information about a particular primary media item (e.g., information pertaining to the identity of a song, artist, and/or album) or playlist of such primary media items, and may be played back in response to a feedback event (e.g., a user-initiated or system-initiated track or playlist change) to provide a user with audio information pertaining to a primary media item or a playlist being played. Further, it shall be understood that the term “enhanced media item” or the like is meant to refer to primary media items having such secondary voice feedback data associated therewith.

“System feedback data” shall be understood to refer to audio feedback that is intended to provide audio information pertaining to the status of a media player application and/or an electronic device executing a media player application. For instance, system feedback data may include system event or status notifications (e.g., a low battery warning tone or message). Additionally, system feedback data may include audio feedback relating to user interaction with a system interface, and may include sound effects, such as click or beep tones as a user selects options from and/or navigates through a user interface (e.g., a graphical interface). Further, the term “duck” or “ducking” or the like, shall be understood to refer to an adjustment of loudness with regard to either a primary or secondary media item during at least a portion of a period in which the primary and the secondary item are being played simultaneously.

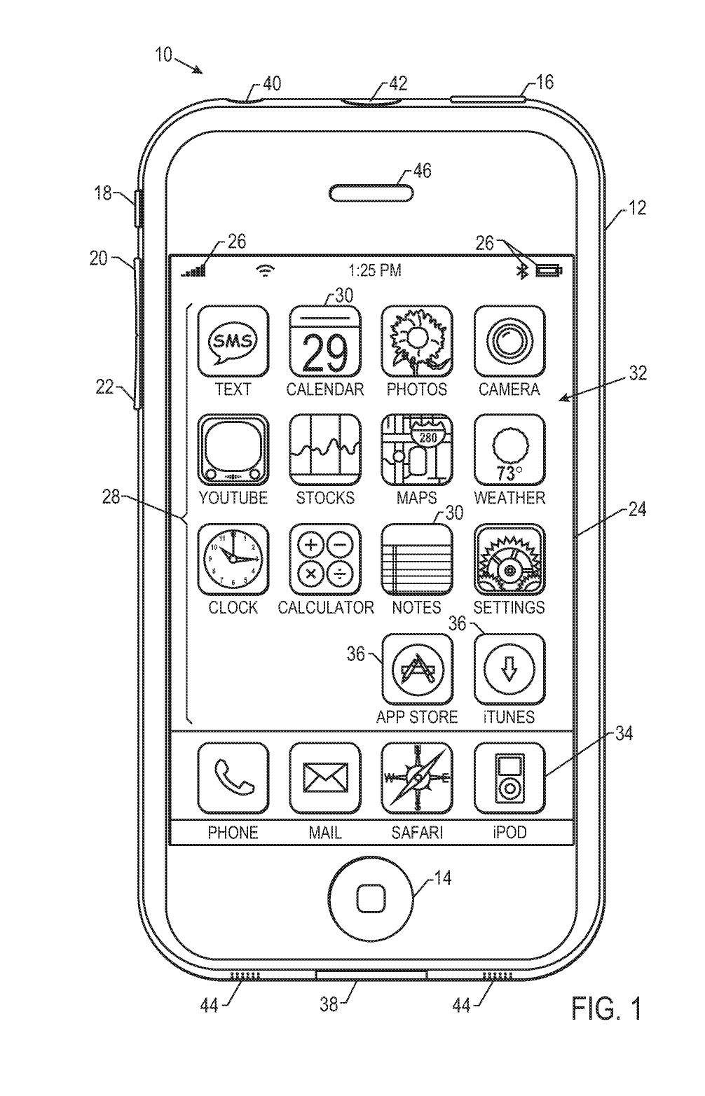

Keeping the above-defined terms in mind, certain embodiments are discussed below with reference to FIGS. 1-10. Those skilled in the art will readily appreciate that the detailed description given herein with respect to these figures is merely intended to provide, by way of example, certain forms that embodiments may take. That is, the disclosure should not be construed as being limited only to the specific embodiments discussed herein.

Turning now to the drawings and referring initially to FIG. 1, a handheld processor-based electronic device that may include an application for playing media files is illustrated and generally referred to by reference numeral 10. While the techniques below are generally described with respect to media playback functions, it should be appreciated that various embodiments of the handheld device 10 may include a number of other functionalities, including those of a cell phone, a personal data organizer, or some combination thereof. Thus, depending on the functionalities provided by the electronic device 10, a user may listen to music, play games, take pictures, and place telephone calls, while moving freely with the device 10. In addition, the electronic device 10 may allow a user to connect to and communicate through the Internet or through other networks, such as local or wide area networks. For example, the electronic device 10 may allow a user to communicate using e-mail, text messaging, instant messaging, or other forms of electronic communication. The electronic device 10 also may communicate with other devices using short-range connection protocols, such as Bluetooth and near field communication (NFC). By way of example only, the electronic device 10 may be a model of an iPod® or an iPhone®, available from Apple Inc. of Cupertino, Calif. Additionally, it should be understood that the techniques described herein may be implemented using any type of suitable electronic device, including non-portable electronic devices, such as a personal desktop computer.

In the depicted embodiment, the device 10 includes an enclosure 12 that protects the interior components from physical damage and shields them from electromagnetic interference. The enclosure 12 may be formed from any suitable material such as plastic, metal or a composite material and may allow certain frequencies of electromagnetic radiation to pass through to wireless communication circuitry within the device 10 to facilitate wireless communication.

The enclosure 12 may further provide for access to various user input structures 14, 16, 18, 20, and 22, each being configured to control one or more respective device functions when pressed or actuated. By way of the user input structures, a user may interface with the device 10. For instance, the input structure 14 may include a button that when pressed or actuated causes a home screen or menu to be displayed on the device. The input structure 16 may include a button for toggling the device 10 between one or more modes of operation, such as a sleep mode, a wake mode, or a powered on/off mode. The input structure 18 may include a dual-position sliding structure that may mute or silence a ringer in embodiments where the device 10 includes cell phone functionality. Further, the input structures 20 and 22 may include buttons for increasing and decreasing the volume output of the device 10. It should be understood that the illustrated input structures 14, 16, 18, 20, and 22 are merely exemplary, and that the electronic device 10 may include any number of user input structures existing in various forms including buttons, switches, control pads, keys, knobs, scroll wheels, and so forth, depending on specific implementation requirements.

The device 10 further includes a display 24 configured to display various images generated by the device 10. The display 24 may also display various system indicators 26 that provide feedback to a user, such as power status, signal strength, call status, external device connections, or the like. The display 24 may be any type of display such as a liquid crystal display (LCD), a light emitting diode (LED) display, an organic light emitting diode (OLED) display, or other suitable display. Additionally, in certain embodiments of the electronic device 10, the display 24 may include a touch-sensitive element, such as a touch screen interface.

As further shown in the present embodiment, the display 24 may be configured to display a graphical user interface (“GUI”) 28 that allows a user to interact with the device 10. The GUI 28 may include various graphical layers, windows, screens, templates, elements, or other components that may be displayed on all or a portion of the display 24. For instance, the GUI 28 may display multiple graphical elements, shown here as multiple icons 30. By default, such as when the device 10 is first powered on, the GUI 28 may be configured to display the illustrated icons 30 as a “home screen,” referred to by the reference numeral 32. In certain embodiments, the user input structures 14, 16, 18, 20, and 22, may be used to navigate through the GUI 28 (e.g., between icons and various screens of the GUI 28). For example, one or more of the user input structures may include a wheel structure that may allow a user to select various icons 30 displayed by the GUI 28. Additionally, the icons 30 may also be selected via the touch screen interface of the display 24. Further, a user may navigate between the home screen 32 and additional screens of the GUI 28 via one or more of the user input structures or the touch screen interface.

The icons 30 may represent various layers, windows, screens, templates, elements, or other graphical components that may be displayed in some or all of the areas of the display 24 upon selection by the user. Furthermore, the selection of an icon 30 may lead to or initiate a hierarchical screen navigation process. For instance, the selection of an icon 30 may cause the display 24 to display another screen that includes one or more additional icons 30 or other GUI elements. As will be appreciated, the GUI 28 may have various components arranged in hierarchical and/or non-hierarchical structures.

In the present embodiment, each icon 30 may be associated with a corresponding textual indicator, which may be displayed on or near its respective icon 30. For example, icon 34 may represent a media player application, such as the iPod® or iTunes® application available from Apple Inc. Icons 36 may represent applications providing the user an interface to an online digital media content provider. By way of the example, the digital media content provider may be an online service providing various downloadable digital media content, including primary (e.g., non-enhanced) or enhanced media items, such as music files, audiobooks, or podcasts, as well as video files, software applications, programs, video games, or the like, all of which may be purchased by a user of the device 10 and subsequently downloaded to the device 10. In one implementation, the online digital media provider may be the iTunes® digital media service offered by Apple Inc.

The electronic device 10 may also include various input/output (I/O) ports, such as the illustrated I/O ports 38, 40, and 42. These I/O ports may allow a user to connect the device 10 to or interface the device 10 with one or more external devices and may be implemented using any suitable interface type such as a universal serial bus (USB) port, serial connection port, FireWire port (IEEE-1394), or AC/DC power connection port. For example, the input/output port 38 may include a proprietary connection port for transmitting and receiving data files, such as media files. The input/output port 40 may be an audio jack that provides for connection of audio headphones or speakers. The input/output port 42 may include a connection slot for receiving a subscriber identify module (SIM) card, for instance, where the device 10 includes cell phone functionality. As will appreciated, the device 10 may include any number of input/output ports configured to connect to a variety of external devices, such as to a power source, a printer, and a computer, or an external storage device, just to name a few.

Certain I/O ports may be configured to provide for more than one function. For instance, in one embodiment, the I/O port 38 may be configured to not only transmit and receive data files, as described above, but may be further configured to couple the device to a power charging interface, such as an power adaptor designed to provide power from a electrical wall outlet, or an interface cable configured to draw power from another electrical device, such as a desktop computer. Thus, the I/O port 38 may be configured to function dually as both a data transfer port and an AC/DC power connection port depending, for example, on the external component being coupled to the device 10 via the I/O port 38.

The electronic device 10 may also include various audio input and output elements. For example, the audio input/output elements, depicted generally by reference numeral 44, may include an input receiver, which may be provided as one or more microphone devices. For instance, where the electronic device 10 includes cell phone functionality, the input receivers may be configured to receive user audio input such as a user's voice. Additionally, the audio input/output elements 44 may include one or more output transmitters. Thus, where the device 10 includes a media player application, the output transmitters of the audio input/output elements 44 may include one or more speakers for transmitting audio signals to a user, such as playing back music files, for example. Further, where the electronic device 10 includes a cell phone application, an additional audio output transmitter 46 may be provided, as shown in FIG. 1. Like the output transmitter of the audio input/output elements 44, the output transmitter 46 may also include one or more speakers configured to transmit audio signals to a user, such as voice data received during a telephone call. Thus, the input receivers and the output transmitters of the audio input/output elements 44 and the output transmitter 46 may operate in conjunction to function as the audio receiving and transmitting elements of a telephone. Further, where a headphone or speaker device is connected to an appropriate I/O port (e.g., port 40), the headphone or speaker device may function as an audio output element for the playback of various media.

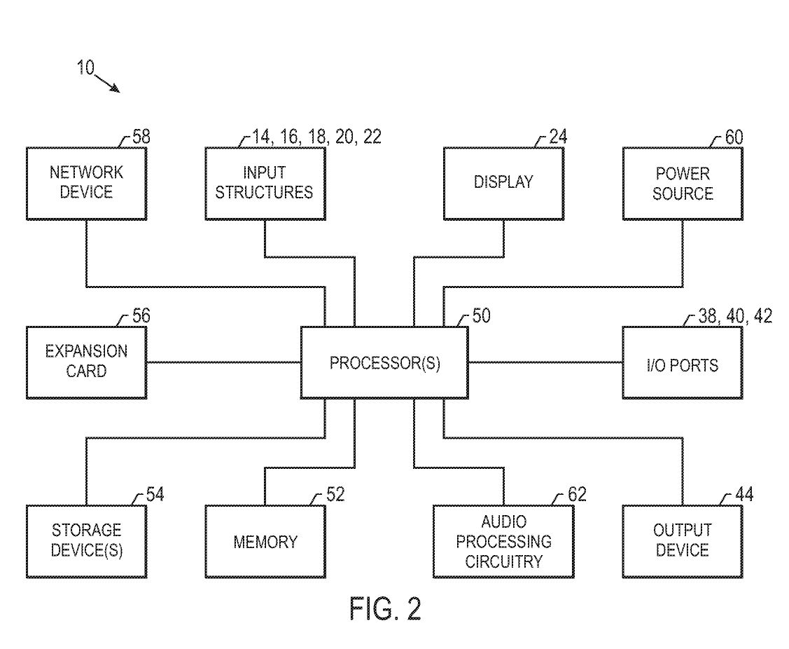

Additional details of the illustrative device 10 may be better understood through reference to FIG. 2, which is a block diagram illustrating various components and features of the device 10 in accordance with one embodiment of the present disclosure. As shown in FIG. 2, the device 10 includes input structures 14, 16, 18, 20, and 22, display 24, the I/O ports 38, 40, and 42, and the output device, which may be an output transmitter (e.g., a speaker) associated with the audio input/output element 44, as discussed above. The device 10 may also include one or more processors 50, a memory 52, a storage device 54, card interface(s) 56, a networking device 58, a power source 60, and an audio processing circuit 62.

The operation of the device 10 may be generally controlled by one or more processors 50, which may provide the processing capability required to execute an operating system, application programs (e.g., including the media player application 34, and the digital media content provider interface application(s) 36), the GUI 28, and any other functions provided on the device 10. The processor(s) 50 may include a single processor or, in other embodiments, may include multiple processors (which, in turn, may include one or more co-processors). By way of example, the processor 50 may include “general purpose” microprocessors, a combination of general and application-specific microprocessors (ASICs), instruction set processors (e.g., RISC), graphics processors, video processors, as well as related chips sets and/or special purpose microprocessors. The processor(s) 50 may be coupled to one or more data buses for transferring data and instructions between various components of the device 10.

The electronic device 10 may also include a memory 52. The memory 52 may include a volatile memory, such as RAM, and/or a non-volatile memory, such as ROM. The memory 52 may store a variety of information and may be used for a variety of purposes. For example, the memory 52 may store the firmware for the device 10, such as an operating system for the device 10, and/or any other programs or executable code necessary for the device 10 to function. In addition, the memory 24 may be used for buffering or caching during operation of the device 10.

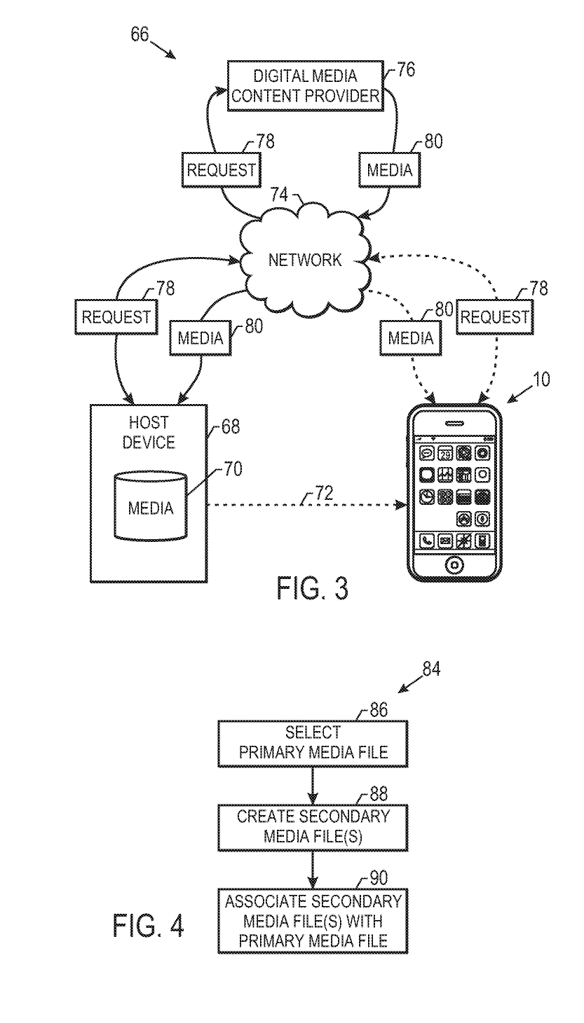

In addition to the memory 52, the device 10 may also include non-volatile storage 54, such as ROM, flash memory, a hard drive, any other suitable optical, magnetic, or solid-state storage medium, or a combination thereof. The storage device 54 may store data files, including primary media files (e.g., music and video files) and secondary media files (e.g., voice or system feedback data), software (e.g., for implementing functions on device 10), preference information (e.g., media playback preferences), transaction information (e.g., information such as credit card information), wireless connection information (e.g., information that may enable media device to establish a wireless connection such as a telephone connection), contact information (e.g., telephone numbers or email addresses), and any other suitable data. Various software programs may be stored in the memory 52 and/or the non-volatile storage 54 (or in some other memory or storage of a different device, such as host device 68 (FIG. 3)), and may include application instructions for execution by a processor to facilitate the techniques disclosed herein.

The embodiment in FIG. 2 also includes one or more card expansion slots 56. The card slots 56 may receive expansion cards that may be used to add functionality to the device 10, such as additional memory, I/O functionality, or networking capability. The expansion card may connect to the device 10 through a suitable connector and may be accessed internally or externally to the enclosure 12. For example, in one embodiment the card may be a flash memory card, such as a SecureDigital (SD) card, mini- or microSD, CompactFlash card, Multimedia card (MMC), etc. Additionally, in some embodiments a card slot 56 may receive a Subscriber Identity Module (SIM) card, for use with an embodiment of the electronic device 10 that provides mobile phone capability.

The device 10 depicted in FIG. 2 also includes a network device 58, such as a network controller or a network interface card (NIC). In one embodiment, the network device 58 may be a wireless NIC providing wireless connectivity over an 802.11 standard or any other suitable wireless networking standard. The network device 58 may allow the device 10 to communicate over a network, such as a local area network, a wireless local area network, or a wide area network, such as an Enhanced Data rates for GSM Evolution (EDGE) network or the 3G network (e.g., based on the IMT-2000 standard). Additionally, the network device 58 may provide for connectivity to a personal area network, such as a Bluetooth® network, an IEEE 802.15.4 (e.g., ZigBee) network, or an ultra wideband network (UWB). The network device 58 may further provide for close-range communications using an NFC interface operating in accordance with one or more standards, such as ISO 18092, ISO 21481, or the TransferJet® protocol.

As will be understood, the device 10 may use the network device 58 to connect to and send or receive data other devices on a common network, such as portable electronic devices, personal computers, printers, etc. For example, in one embodiment, the electronic device 10 may connect to a personal computer via the network device 58 to send and receive data files, such as primary and/or secondary media files. Alternatively, in some embodiments the electronic device may not include a network device 58. In such an embodiment, a NIC may be added into card slot 56 to provide similar networking capability as described above.

The device 10 may also include or be connected to a power source 60. In one embodiment, the power source 60 may be a battery, such as a Li-Ion battery. In such embodiments, the battery may be rechargeable, removable, and/or attached to other components of the device 10. Additionally, in certain embodiments the power source 60 may be an external power source, such as a connection to AC power, and the device 10 may be connected to the power source 60 via an I/O port 38.

To facilitate the simultaneous playback of primary and secondary media, the device 10 may include an audio processing circuit 62. In some embodiments, the audio processing circuit 62 may include a dedicated audio processor, or may operate in conjunction with the processor 50. The audio processing circuitry 62 may perform a variety functions, including decoding audio data encoded in a particular format, mixing respective audio streams from multiple media files (e.g., a primary and a secondary media stream) to provide a composite mixed output audio stream, as well as providing for fading, cross fading, or ducking of audio streams.

As described above, the storage device 54 may store a number of media files, including primary media files, secondary media files (e.g., including voice feedback and system feedback media). As will be appreciated, such media files may be compressed, encoded and/or encrypted in any suitable format. Encoding formats may include, but are not limited to, MP3, AAC or AACPlus, Ogg Vorbis, MP4, MP3Pro, Windows Media Audio, or any suitable format. To playback media files stored in the storage device 54, the files may need to be first decoded. Decoding may include decompressing (e.g., using a codec), decrypting, or any other technique to convert data from one format to another format, and may be performed by the audio processing circuitry 62. Where multiple media files, such as a primary and secondary media file are to be played concurrently, the audio processing circuitry 62 may decode each of the multiple files and mix their respective audio streams in order to provide a single mixed audio stream. Thereafter, the mixed stream is output to an audio output element, which may include an integrated speaker associated with the audio input/output elements 44, or a headphone or external speaker connected to the device 10 by way of the I/O port 40. In some embodiments, the decoded audio data may be converted to analog signals prior to playback.

The audio processing circuitry 62 may further include logic configured to provide for a variety of dynamic audio ducking techniques, which may be generally directed to adaptively controlling the loudness or volume of concurrently outputted audio streams. As discussed above, during the concurrent playback of a primary media file (e.g., a music file) and a secondary media file (e.g., a voice feedback file), it may be desirable to adaptively duck the volume of the primary media file for a duration in which the secondary media file is being concurrently played in order to improve audio perceptibility from the viewpoint of a listener.

Though not specifically shown in FIG. 2, it should be appreciated that the audio processing circuitry 62 may include a memory management unit for managing access to dedicated memory (e.g., memory only accessible for use by the audio processing circuit 62). The dedicated memory may include any suitable volatile or non-volatile memory, and may be separate from, or a part of, the memory 52 discussed above. In other embodiments, the audio processing circuitry 62 may share and use the memory 52 instead of or in addition to the dedicated audio memory. It should be understood that the dynamic audio ducking logic mentioned above may be stored in a dedicated memory or the main memory 52.

Referring now to FIG. 3, a networked system 66 through which media items may be transferred between a host device (e.g., a personal desktop computer) 68, the portable handheld device 10, or a digital media content provider 76 is illustrated. As shown, a host device 68 may include a media storage device 70. Though referred to as a media storage device 70, it should be understood that the storage device may be any type of general purpose storage device, including those discussed above with reference to the storage device 54, and need not be specifically dedicated to the storage of media data 80.

In the present implementation, media data 80 stored by the storage device 70 on the host device 68 may be obtained from a digital media content provider 76. As discussed above, the digital media content provider 76 may be an online service, such as iTunes®, providing various primary media items (e.g., music, audiobooks, etc.), as well as electronic books, software, or video games, that may be purchased and downloaded to the host device 68. In one embodiment, the host device 68 may execute a media player application that includes an interface to the digital media content provider 76. The interface may function as a virtual store through which a user may select one or more media items 80 of interest for purchase. Upon identifying one or more media items 80 of interest, a request 78 may be transmitted from the host device 68 to the digital media content provider 76 by way of the network 74, which may include a LAN, WLAN, WAN, or PAN network, or some combination thereof. The request 78 may include a user's subscription or account information and may also include payment information, such as a credit card account. Once the request 78 has been approved (e.g., user account and payment information verified), the digital media content provider 76 may authorize the transfer of the requested media 80 to the host device 68 by way of the network 74.

Once the requested media item 80 is received by the host device 68, it may be stored in the storage device 70 and played back on the host device 68 using a media player application. Additionally, the media item 80 may further be transmitted to the portable device 10, either by way of the network 74 or by a physical data connection, represented by the dashed line 72. By way of example, the connection 72 may be established by coupling the device 10 (e.g., using the I/O port 38) to the host device 68 using a suitable data cable, such as a USB cable. In one embodiment, the host device 68 may be configured to synchronize data stored in the media storage device 70 with the device 10. The synchronization process may be manually performed by a user, or may be automatically initiated upon detecting the connection 72 between the host device 68 and the device 10. Thus, any new media data (e.g., media item 80) that was not stored in the storage device 70 during the previous synchronization will be transferred to the device 10. As may be appreciated, the number of devices that may “share” the purchased media 80 may be limited depending on digital rights management (DRM) controls that are sometimes included with digital media for copyright purposes.

The system 66 may also provide for the direct transfer of the media item 80 between the digital media content provider 76 and the device 10. For instance, instead of obtaining the media item from the host device 68, the device 10 (e.g., using the network device 58) may connect to the digital media content provider 76 via the network 74 in order to request a media item 80 of interest. Once the request 78 has been approved, the media item 80 may be transferred from the digital media content provider 76 directly to the device 10 using the network 74.

As will be discussed in further detail below, a media item 80 obtained from the digital content provider 76 may include only primary media data or may be an enhanced media item having both primary and secondary media items. Where the media item 80 includes only primary media data, secondary media data (e.g., voice feedback data) may subsequently be created locally on the host device 68 or the portable device 10.

By way of example, a method 84 for creating one or more secondary media items is generally depicted in FIG. 4 in accordance with one embodiment. The method 84 begins with the selection of a primary media item in a step 86. For instance, the selected primary media item may be a media item that was recently downloaded from the digital media content provider 76. Once the primary media item is selected, one or more secondary media items may be created in a step 88. As discussed above, the secondary media items may include voice feedback data (e.g., voiceover announcements) and may be created using any suitable technique. In one embodiment, the secondary media items are voice feedback data that may be created using a voice synthesis program. For example, the voice synthesis program may process the primary media item to extract metadata information, which may include information pertaining to a song title, album name, or artist name, to name just a few. The voice synthesis program may process the extracted information to generate one or more audio files representing synthesized speech, such that when played back, a user may hear the song title, album name, and/or artist name being spoken. As will be appreciated, the voice synthesis program may be implemented on the host device 68, the handheld device 10, or on a server associated with the digital media content provider 76. In one embodiment, the voice synthesis program may be integrated into a media player application, such as iTunes®.

In another embodiment, rather than creating and storing secondary voice feedback items, a voice synthesis program may extract metadata information on the fly (e.g., as the primary media item is played back) and output a synthesized voice announcement. Although such an embodiment reduces the need to store secondary media items alongside primary media items, on-the-fly voice synthesis programs that are intended to provide a synthesized voice output on demand are generally less robust, limited to a smaller memory footprint, and may have less accurate pronunciation capabilities when compared to voice synthesis programs that render the secondary voice feedback files prior to playback.

The secondary voice feedback items created at step 86 may be also generated using voice recordings of a user's own voice. For instance, once the primary media item is received (step 84), a user may select an option to speak a desired voice feedback announcement into an audio receiver, such as a microphone device connected to the host device 68, or the audio input/output elements 44 on the handheld device 10. The spoken portion recorded through the audio receiver may be saved as the voice feedback audio data that may be played back concurrently with the primary media item.

Next, the method 84 concludes at step 90, wherein the secondary media items created at step 88 are associated with the primary media item received at step 86. As mentioned above, the association of primary and secondary media items may collectively be referred to as an enhanced media item. As will be discussed in further detail below, depending on the configuration of a media player application, upon playback of the enhanced media item, secondary media data may be played concurrently with at least a portion of the primary media item to provide a listener with information about the primary media item using voice feedback.

As will be appreciated, the method 84 shown in FIG. 4 may be implemented by either the host device 68 or the handheld device 10. For example, where the method 84 is performed by the host device 68, the selected primary media item (step 86) may be received from the digital media content provider 76 and the secondary media items may be created (step 88) locally using either the voice synthesis or voice recording techniques summarized above to create enhanced media items (step 90). The enhanced media items may subsequently be transferred from the host device 68 to the handheld device 10 by a synchronization operation, as discussed above.

Additionally, in an embodiment where the method 84 is performed on the handheld device 10, the selected primary media item (step 86) may be received from either the host device 68 or the digital media content provider 76. The handheld device 10 may create the necessary secondary media items (step 88) using one or more of the techniques described above. Thereafter, the created secondary media items may be associated with the primary media item (step 90) to create enhanced media items which may be played back on the handheld device 10.

Enhanced media items may, depending on the configuration of a media player application, provide for the playback of one or more secondary media items concurrently with at least a portion of a primary media item in order to provide a listener with information about the primary media item using voice feedback, for instance. In other embodiments, secondary media items may constitute system feedback data which are not necessarily associated with a specific primary media item, but may be played back as necessary upon the detection of occurrence of certain system events or states (e.g., low battery warning, user interface sound effect, etc.).

The method 84 may also be performed by the digital media content provider 76. For instance, voice feedback items may be previously recorded by a recording artist and associated with a primary media item to create an enhanced media item which may purchased by users or subscribers of the digital media content service 76. In such embodiments, when the enhanced media file is played back on either the host device 68 or the handheld device 10, the pre-associated voice feedback data may be concurrently played, thereby allowing a user to listen to a voice feedback announcement (e.g., artist, track, album, etc.) or commentary that is spoken by the recording artist. In the context of a virtual store setting, enhanced media items having pre-associated voice feedback data may be offered by the digital content provider 76 at a higher price than non-enhanced media items which include only primary media data.

In further embodiments, the requested media item 80 may include only secondary media data. For instance, if a user had previously purchased only a primary media item without voice feedback data, the user may have the option of requesting any available secondary media content separately at a later time for an additional charge in the form of an upgrade. Once received, the secondary media data may be associated with the previously purchased primary media item to create an enhanced media item.

In still further embodiments, secondary media items may also be created with respect to a defined group of multiple media files. For instance, many media player applications currently permit a user to define the group of media files as a “playlist.” Thus, rather than repeatedly queuing each of the media files each time a user wishes to listen to the media files, the user may conveniently select a defined playlist to load the entire group of media files without having to specify the location of each media file.

Accordingly, in one embodiment, step 86 may include selecting multiple media files for inclusion in a playlist. For example, the selected media files may include a user's favorite songs, an entire album by a recording artist, multiple albums by one or more particular recording artists, an audiobook, or some combination thereof. Once the appropriate media files have been selected, the user may save the selected files as a playlist. Generally, the option to save a group of media files as a playlist may be provided by a media player application.

Next, in step 88, a secondary media item may be created for the defined playlist. The secondary media item may, for example, be created based on the name that the user assigned to the playlist and using the voice synthesis or voice recording techniques discussed above. Finally, at step 90, the secondary media item may be associated with the playlist. For example, if the user assigned the name “Favorite Songs” to the defined playlist, a voice synthesis program may create and associate a secondary media item with playlist, such that when the playlist is loaded by the media player application or when a media item from the playlist is initially played, the secondary media item may be played back concurrently and announce the name of the playlist as “Favorite Songs.”

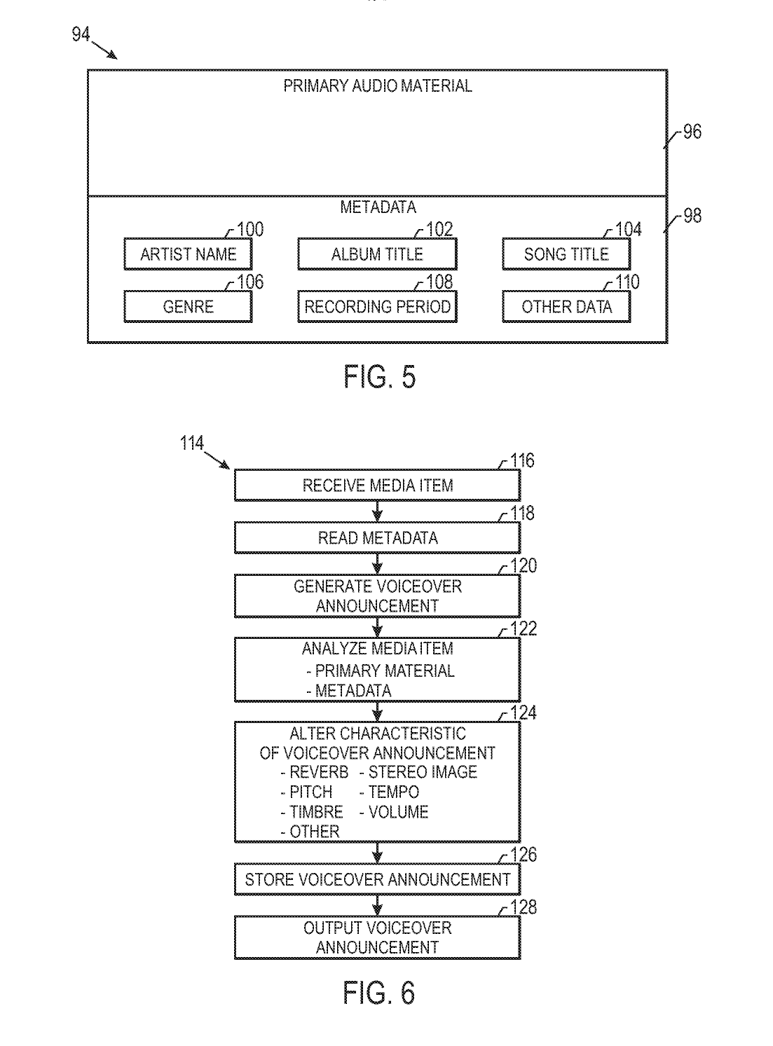

A graphical depiction of a primary media file 94 is provided in FIG. 5 in accordance with one embodiment. The media file 94 may include primary audio material 96 that may be output to a user, such as via the electronic device 10 or the host device 68. The primary audio material 96 may include a song or other music, an audiobook, a podcast, or any other audio and/or video data that is electronically stored for future playback. The media file 94 may also include metadata 98, such as various tags that store data pertaining to the primary audio material 96. For instance, in the depicted embodiment, the metadata 98 includes artist name 100, album title 102, song title 104, genre 106, recording period 108 (e.g., date, year, decade, etc.), and/or other data 110.

Voice feedback data, such as a voiceover announcement or other audio feedback associated with a media item (e.g., the media file 94), may be processed in accordance with a method 114, which is generally depicted in FIG. 6 in accordance with one embodiment. The method 114 may include receiving a media item at step 116. The method 114 may also include reading metadata of the media item in a step 118, and generating a secondary media item, such as a voiceover announcement or other voice feedback, in a step 120. For example, as generally discussed above, a voice synthesizing program may convert indications of artist name, album title, song title, and the like, into one or more voiceover announcements. Such generation of the voiceover announcements may be performed by the host device 68, the electronic device 10, or some other device. Additionally, in some embodiments, such voiceover announcements may already be included in a media item or may be provided in some other manner, as also discussed above.

In a step 122, the electronic device 10 or the host device 68 may analyze the media item, and may alter a characteristic of the voiceover announcement in a step 124. As discussed in greater detail below, such analysis of the media item may include analysis of primary audio material, metadata associated with the primary audio material or media item, or both. Analysis of the primary audio material may be achieved through various techniques, such as spectral analysis, cepstral analysis, or any other suitable analytic techniques. Alteration of a characteristic of the voiceover announcement or other voice feedback may be based on a parameter determined through analysis of the media item. For instance, in some embodiments, the parameters on which the alteration of the voiceover announcement is based may include one or more of a reverberation parameter, a timbre parameter, a pitch parameter, a volume parameter, an equalization parameter, a tempo parameter, a music genre, or recording date or year information. It is noted, however, that other contextual parameters may also or instead be used as bases for varying a characteristic of voice or other audio feedback in full accordance with the present techniques. Further, in some embodiments, the modification of such feedback characteristics may be based on audio events in the recorded primary audio material (e.g., fade in, fade out, drum beat, cymbal crash, or change in dynamics).

Various characteristics of the voiceover announcement that may be altered at step 124 based on the context of the primary audio material include, among others, a reverberation characteristic, a pitch characteristic, a timbre characteristic, a tempo characteristic, a volume characteristic, a balance (or equalization) characteristic, some other frequency response characteristic and the like. Additionally, the voiceover announcement may also be given a stereo image for output to a user. The voiceover announcement (or other audio feedback) may be altered through various processing techniques, such as through application of various audio filters (e.g., frequency filters, feedback filters to adjust reverberation, etc.), through changing the speed of the voiceover announcement, through individual or collective adjustment of characteristics of interest, and so forth. As discussed in greater detail below, variation of the one or more voiceover announcement characteristics may result in a listener perceiving a combined audio output of the voiceover announcement played back with its associated primary audio material as having a more cohesive sound.

In a step 126, the altered voiceover announcement may be stored in a memory device of the electronic device 10 or host device 68 for future playback. Additionally, in a step 128, the altered voiceover announcement may also be output to a listener. In some embodiments, such as those in which the voiceover announcement is altered during (rather than before) playback of the media item based on the analysis of the media item, the method may include outputting the altered voiceover announcement without storing the announcement for future playback. It is again noted that aspects of the presently disclosed techniques, such as the analysis of a media item and alteration of a voice feedback characteristic, may be implemented via execution of application instructions or software routines by a processor of an electronic device.

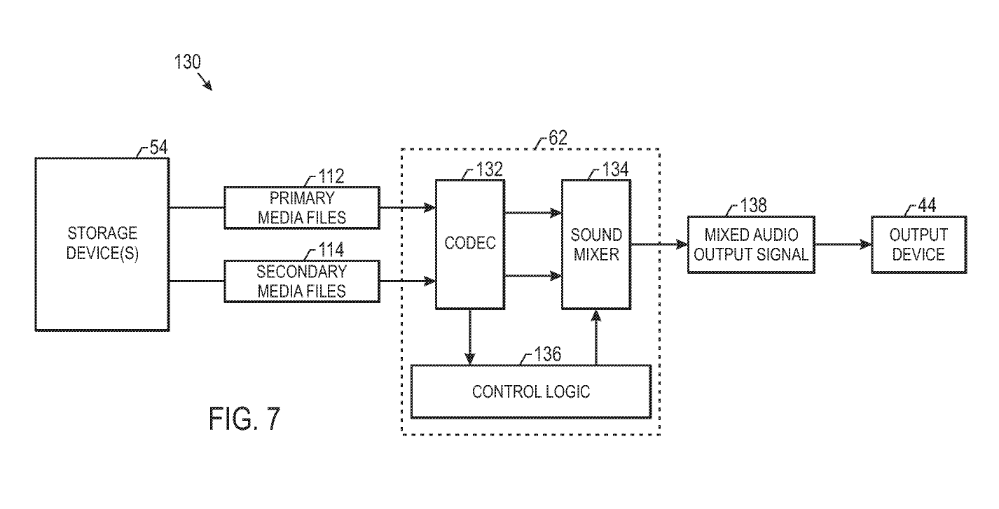

FIG. 7 illustrates a schematic diagram of a process 130 by which a primary media item 112 and a secondary media item 114 may be processed by the audio processing circuitry 62 and concurrently output as a mixed audio stream. The process may be performed by any suitable device, such as the electronic device 10 or the host device 68. As discussed above, the primary media item 112 and secondary media item 114 may be stored in the storage device 54 and may be retrieved for playback by a media player application, such as iTunes®. As will be appreciated, generally, the secondary media item is retrieved when a particular feedback event requesting the playback of the secondary media item is detected. For instance, a feedback event may be a track change or playlist change that is manually initiated by a user or automatically initiated by a media player application (e.g., upon detecting the end of a primary media track). Additionally, a feedback event may occur on demand by a user. For instance, the media player application may provide a command that the user may select (e.g., via a GUI and/or interaction with a physical input structure) in order to hear voice feedback while a primary media item is playing.

Additionally, where the secondary media item is a system feedback announcement that is not associated with any particular primary media item, a feedback event may be the detection a certain device state or event. For example, if the charge stored by the power source 60 (e.g., battery) of the device 10 drops below a certain threshold, a system feedback announcement may be played concurrently with a current primary media track to inform the user of the state of the device 10. In another example, a system feedback announcement may be a sound effect (e.g., click or beep) associated with a user interface (e.g., GUI 28) and may be played as a user navigates the interface. As will be appreciated, the use of voice and system feedback techniques on the device 10 may be beneficial in providing a user with information about a primary media item or about the state of the device 10. Further, in an embodiment where the device 10 does not include a display and/or graphical interface, a user may rely extensively on voice and system feedback announcements for information about the state of the device 10 and/or primary media items being played back on the device 10. By way of example, a device 10 that lacks a display and graphical user interface may be a model of an iPod Shuffle®, available from Apple Inc.

When a feedback event is detected, the primary and secondary media items 112 and 114 may be processed and output by the audio processing circuitry 62. It should be understood, however, that the primary media item 112 may have been playing prior to the feedback event, and that the period of concurrent playback does not necessarily have to occur at the beginning of the primary media track. As shown in FIG. 7, the audio processing circuitry 62 may include a coder-decoder component (codec) 132, a mixer 134, and control logic 136. The codec 132 may be implemented via hardware and/or software, and may be utilized for decoding certain types of encoded audio formats, such as MP3, AAC or AACPlus, Ogg Vorbis, MP4, MP3Pro, Windows Media Audio, or any suitable format. The respective decoded primary and secondary streams may be received by the mixer 134. The mixer 134 may also be implemented via hardware and/or software, and may perform the function of combining two or more electronic signals (e.g., primary and secondary audio signals) into a composite output signal 138. The composite signal 138 may be output to an output device, such as the audio input/output elements 44.

Generally, the mixer 134 may include multiple channel inputs for receiving respective audio streams. Each channel may be manipulated to control one or more aspects of the received audio stream, such as timbre, pitch, reverberation, volume, or speed, to name just a few. The mixing of the primary and secondary audio streams by the mixer 134 may be controlled by the control logic 136. The control logic 136 may include both hardware and/or software components, and may be configured to alter the secondary media data 114 (e.g., a voiceover announcement) based on the primary media data 112 in accordance with the present techniques. For instance, the control logic 136 may apply one or more audio filters to the voiceover announcement, may alter the tempo of the voiceover announcement, and so forth. In other embodiments, however, the secondary media files 114 may include voice feedback that has already been altered based on contextual parameters of the primary media files 112 prior to input of the secondary media files 114 to the audio processing circuitry 62. Further, though shown as being a component of the audio processing circuitry 62 (e.g., stored in dedicated memory, as discussed above) in the present figure, it should be understood that the control logic 136 may also be implemented separately, such as in the main memory 52 (e.g., as part of the device firmware) or as an executable program stored in the storage device 54, for example.

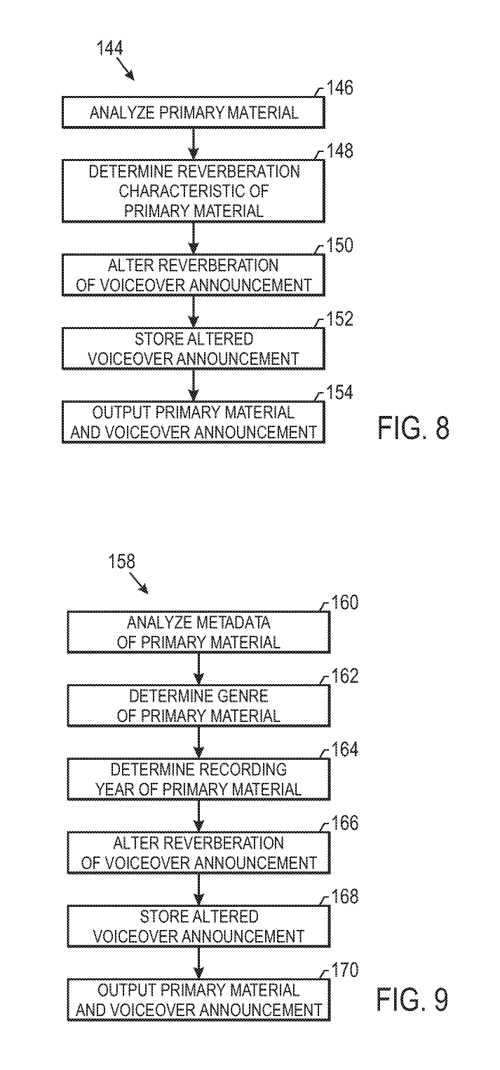

Further examples of the varying of voice feedback characteristics are discussed below with reference to FIGS. 8-10. Particularly, a process for varying a reverberation characteristic of a voiceover announcement is generally depicted in FIG. 8 in accordance with one embodiment. The method 144 may include a step 146 of analyzing primary audio material (e.g., music, speech, or a video soundtrack) of a media item. From such analysis, a reverberation characteristic of the primary audio material may be determined in a step 148.

As may be appreciated, the reverberation characteristics of the primary audio material may depend on the acoustics of the venue at which the primary audio material was recorded. For example, large concert halls, churches, arenas, and the like may exhibit substantial reverberation, while smaller venues, such as recording studios, clubs, or outdoor settings may exhibit less reverberation. In addition, the reverberation characteristics of a particular venue may also depend on a number of other acoustic factors, such as the sound-reflecting and sound-absorbing properties of the venue itself. Still further, reverberation characteristics of the originally-recorded material may be modified through various recording and/or post-recording processing techniques.

During playback of the primary audio material and a voiceover announcement, wide variations in reverberation characteristics of these two items may result in the voiceover announcement sounding artificial and incongruous with the primary audio material. In one embodiment, however, the method 144 includes a step 150 of altering a reverberation characteristic of the voiceover announcement based on a reverberation characteristic of its associated primary audio material. The reverberation characteristic of the voiceover announcement may be modified to more closely approximate that of the primary audio material, which may result in a user perceiving a voiceover announcement (played concurrently with or close in time to the primary audio material) to be more natural. For instance, if it is determined that a music track has significant reverberation, the reverberation of a voiceover announcement associated with the music track (e.g., a song title, artist name, or playlist name) may be increased to make the voiceover announcement sound as if it were recorded in the same venue as the music track. Conversely, the reverberation characteristic of the voiceover announcement may be modified to further diverge from that of the primary audio material, which may further distinguish the voiceover announcement from the primary audio material during playback to a listener.

In some embodiments, the altered voiceover announcement may be stored in a step 152 for future playback to a user. The primary audio material and the voiceover announcement may be subsequently output to a user in a step 154, as generally described above with respect to FIG. 7. In another embodiment, such as one in which the voiceover announcement is altered on-the-fly during playback of its associated media, the voiceover announcement may be altered and output over the primary audio material without storing the altered voiceover announcement for later use.

Additionally, reverberation or other characteristics of the voiceover announcement may be varied based on metadata associated with primary audio material, as generally depicted in FIG. 9 in accordance with one embodiment. It is noted that such variation based on metadata may be applied in addition to, or in place of, any alterations made to the voiceover announcement based on analysis of the primary audio material itself.

With respect to presently depicted embodiment, a method 158 includes a step 160 of analyzing metadata of the primary audio material. From such analysis, the genre of the primary audio material may be determined in a step 162 and/or the recording period (e.g., date, year, or decade the source material was originally recorded) may be determined in a step 164. The results of the analysis of the metadata, including the genre of the primary audio material, the recording period of the primary audio material, other information obtained from the metadata, or some combination thereof, may be used as a basis for altering the reverberation characteristic of the voiceover announcement in a step 166.

For example, a “pop” track from the 1980's will typically have more reverberation than a pop track from the 2000's. Thus, if the metadata indicates that the primary audio material is a pop song from the 1980's, the reverberation of the voiceover announcement may be increased (e.g., to match or more closely approximate the reverberation of the primary audio material) in the step 166. In another example, many types of jazz music may exhibit relatively low reverberation levels, while many types of classical music may include relatively high reverberation levels. Thus, voiceover announcements for jazz music may be adjusted to have lower reverberation (relative to certain other genres), while voiceover announcements for classical music may be adjusted to give it higher reverberation levels (also relative to certain other genres). It is noted that adjustment of the reverberation (or other characteristics) of voiceover announcements in step 166 may be made based on the genre determined in step 162, the recording period determined in step 164, other information regarding the primary audio material, or some combination thereof. In steps 168 and 170, the altered voiceover announcement or other voice feedback may be stored and the primary audio material and voiceover announcement may be output, as generally described above.

In addition to modifying reverberation, analysis of a media item may be used to alter other acoustic characteristics of the voiceover announcement. Indeed, while certain representative examples of the modification of voice feedback characteristics are provided herein, it is noted that the present techniques may be employed to vary any suitable characteristic of voice feedback based on contextual parameters of associated primary media items.

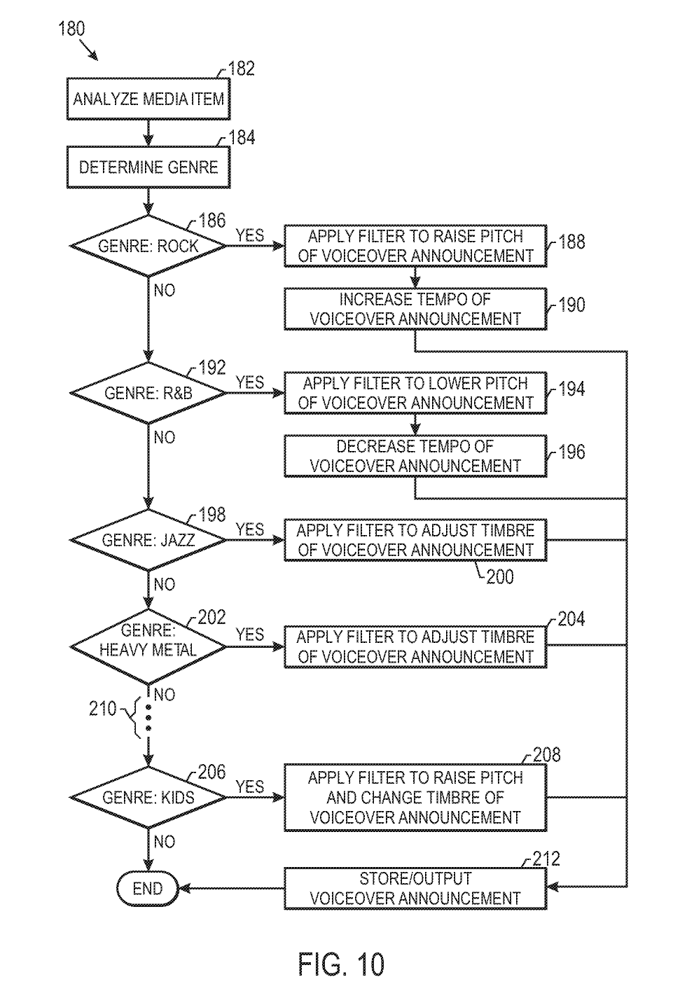

By way of example, and as generally depicted in FIG. 10 in accordance with one embodiment, pitch characteristics, timbre characteristics, tempo characteristics, and other characteristics of the voiceover announcement may be varied based on the analysis of a media item. For instance, a method 180 may include a step 182 of analyzing a media item and a step 184 determining a genre of the media item based on such analysis. The analysis of the media item may include analysis of primary audio material, analysis of metadata, or analysis of other portions of a media item. For example, in one embodiment, the genre of the media item may be determined from a metatag of the media item.

Based on the determined genre, the method 180 may then include varying characteristics of a voiceover announcement (or other audio feedback) based on the identified genre. Particularly, if the identified genre is “Rock” music (decision block 186), the method 180 may include applying an audio filter to raise the pitch of the voiceover announcement in a step 188. Additionally, further adjustments to the voiceover announcement may be made, such as increasing the tempo of the voiceover announcement in a step 190. If the genre is determined to be “R&B” music (decision block 192), an audio filter may be applied to the voiceover announcement to lower its pitch and the tempo of the voiceover announcement may be decreased in steps 194 and 196, respectively.

If the identified genre is “Jazz” music (decision block 198), an audio filter may be applied to the voiceover announcement to adjust the timbre (e.g., the sound color) of the voiceover announcement in a step 200. For example, the audio filter may be applied in a step 200 to make the speech of the voiceover announcement sound more “smooth”, such as by varying the relative intensities of overtones of the voiceover announcement to emphasize harmonic overtones. Similarly, if the identified genre is “Heavy Metal” music (decision block 202), an audio filter may be applied to adjust the timbre of the voiceover announcement in a step 204 to make the speech of the voiceover announcement sound more gruff or distorted. Still further, if the identified genre is “Children's” music (decision block 206), the method 180 may include a step 208 of applying an audio filter to the voiceover announcement to raise its pitch and change its timbre. For example, in one embodiment, one or more such filters may be applied to make the speech of the voiceover announcement sound like a children's cartoon character (e.g., a chipmunk).

It is further noted that additional genres may be identified, as generally represented by reference 210, and that various other alterations of an associated voiceover announcement may be made based on such an identification. Further, while certain music genres have been provided by way of example, it is noted that the genres may also or instead include non-music genres, such as various speech genres (e.g., news, comedy, audiobook, etc.). Additionally, once a voiceover announcement is altered based on the identified genre, the altered voiceover announcement may be stored, output, or both, in a step 212, as generally described above.

In various embodiments, the context-based alterations described above with respect to the voice feedback may allow customization of the voice feedback to an extent that a listener may perceive any number of different “personalities” as providing feedback for various distinct media items. For example, through the above techniques, a synthetic voice feedback may be made to sound male or female, old or young, happy or sad, agitated or relaxed, and so forth, based on the context of an associated primary media item or playlist. Further, the voice feedback may be altered to add different linguistic accents to the speech depending on the genre or some other contextual aspect of the media item.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method comprising:
receiving a media file at an electronic device;
reading metadata from the media file, the metadata including information pertaining to audio material encoded in the media file;
generating via a speech synthesizer a voiceover announcement associated with the media file, wherein the voiceover announcement includes a synthesized voice to communicate one or more items of the information pertaining to the audio material; and
altering a reverberation characteristic of the synthesized voice based on analysis of the media file.

2. The method of claim 1, wherein altering the reverberation characteristic of the synthesized voice based on analysis of the media file includes altering the reverberation characteristic of the synthesized voice based on analysis of a reverberation characteristic of the audio material.

3. The method of claim 1, wherein altering the reverberation characteristic of the synthesized voice includes altering the reverberation characteristic of the synthesized voice based on a genre associated with the audio material.

4. The method of claim 1, comprising outputting the voiceover announcement.

5. The method of claim 4, wherein outputting the voiceover announcement includes outputting at least one of a title or a performer associated with the audio material.

6. An electronic device comprising:
a processor;
a storage device configured to store a plurality of media items;
a memory device configured to store a media player application executable by the processor, wherein the media player application facilitates playback of one or more of the plurality of media items by the electronic device;
an audio processing circuit configured to mix a plurality of audio input streams into a composite audio output stream, wherein the plurality of audio input streams includes a first input audio input stream corresponding to at least one media item of the plurality of media items and a second input audio stream that provides a spoken indication of identifying data corresponding to the at least one media item, and wherein the spoken indication is altered based on an analyzed parameter of the at least one media item; and
an audio output device configured to output the composite audio output stream.

7. The electronic device of claim 6, wherein the electronic device is configured to generate the second input audio stream from an analysis of the at least one media item.

8. The electronic device of claim 6, comprising a speech synthesizer configured to generate the second input audio stream via analysis of the at least one media item.

9. The electronic device of claim 6, comprising a display configured to display a graphical user interface associated with the media player application.

10. The electronic device of claim 6, wherein the electronic device includes a portable digital media player.

11. A method comprising:
analyzing a media file;
generating synthesized speech for playback to a user to aurally provide information pertaining to the media file to the user; and
processing the synthesized speech to vary at least one acoustic characteristic of the synthesized speech based on the analysis of the media file.

12. The method of claim 11, wherein analyzing the media file includes analyzing metadata associated with audio encoded in the media file, and wherein processing the synthesized speech includes processing the synthesized speech to vary at least one of pitch or timbre of the synthesized speech based on the metadata.

13. The method of claim 12, wherein the metadata includes a genre of the audio encoded in the media file, and processing the synthesized speech includes processing the synthesized speech to vary at least one of pitch or timbre of the synthesized speech based on the genre.

14. The method of claim 11, wherein analyzing the media file includes determining a reverberation characteristic of audio encoded in the media file, and wherein processing the synthesized speech includes processing the synthesized speech to vary a reverberation characteristic of the synthesized speech based on the reverberation characteristic of the audio encoded in the media file.

15. The method of claim 11, wherein analyzing the media file includes analyzing metadata associated with audio encoded in the media file, the metadata including an indication of when material of the encoded audio was originally recorded, and wherein processing the synthesized speech includes processing the synthesized speech to add an acoustic effect to the synthesized speech based on the indication.

16. The method of claim 11, comprising outputting the synthesized speech to the user.

17. The method of claim 11, comprising storing the synthesized speech in a memory device for future playback.

18. A method comprising:
receiving a primary media item; and
applying an audio filter to speech of a secondary media item associated with the primary media item, wherein one or more characteristics of the applied audio filter are determined based on one or more parameters relating to the primary media item.

19. The method of claim 18, wherein applying an audio filter includes applying an audio filter configured to alter the speech of the secondary media item by altering each of a pitch characteristic, a timbre characteristic, a tempo characteristic, an equalization characteristic, and a reverberation characteristic.

20. The method of claim 18, wherein applying an audio filter includes applying an audio filter having one or more characteristics that are determined based on the one or more parameters relating to the primary media item, the one or more parameters including each of a reverberation parameter, a timbre parameter, a volume parameter, a pitch parameter, a tempo parameter, and a music genre.

21. The method of claim 18, comprising creating a stereo image of the voiceover output.

22. A manufacture comprising:
one or more tangible, computer-readable storage media having application instructions encoded thereon for execution by a processor, the application instructions comprising:
instructions for receiving a media item;
instructions for synthesizing voiceover information for the media item;
instructions for altering at least one output characteristic of the synthesized voiceover information based on at least one contextual parameter of the media item; and
instructions for storing the altered synthesized voiceover information.

23. The manufacture of claim 22, wherein the application instructions include instructions for outputting the altered synthesized voiceover information to a user.

24. The manufacture of claim 22, wherein the instructions for altering the at least one output characteristic of the synthesized voiceover information includes instructions for altering at least one of a reverberation characteristic, a pitch characteristic, or a timbre characteristic of the synthesized voiceover information based on the at least one contextual parameter of the media item.

25. The manufacture of claim 22, wherein the one or more tangible, computer-readable storage media include at least one of a magnetic storage media or a solid state storage media.
